(19) United States
(12) Patent Application Publication
(10) Pub. No.: US 2005/0112472 A1
(43) Pub. Date: May 26, 2005

(54) Seamless holographic embossing substrate produced by laser ablation

(76) Inventors: Wilhelm P. Kutsch, Fountain Hills, AZ (US); Anthony W. Heath, Portsmouth, NH (US); Jeffrey S. Gagnon, Candia, NH (US)

Correspondence Address: PAUL F. DONOVAN;ILLINOIS TOOL WORKS INC., 3600 WEST LAKE AVENUE, GLENVEIW, IL, 60025, US

(21) Appl. No.: 10/717,885

(22) Filed: Nov. 20, 2003

(51) Int. Cl. G03H 1/04

(52) U.S. Cl. 430/1; 430/2; 430/321; 359/35

(57) ABSTRACT

Laser ablation to direct write dot matrix holographic patterns onto the surface of polymeric coatings deposited on an embossing cylinder is described. The desired holographic pattern is ablated by interfering at least two laser beams directly onto the polymeric coating of the embossing cylinder in the pixel-by-pixel manner. The direct write laser ablation technique eliminates the size limitations of the holographic pattern created on the surface of the embossing cylinder, the need to combine smaller images to create a larger shim and the very need to use the shims, since large seamless embossing cylinders can be directly pixel-by-pixel ablated with larger sized images of great variety. The polymeric coatings for further direct write laser ablation can be deposited onto the embossing cylinder by various methods, including, but not limited to, molding or coating.

### FIELD OF THE INVENTION

The present invention relates to producing seamless holographic pattern embossing substrates using the method of laser ablation of the outer surface of the substrate.

### BACKGROUND OF THE INVENTION

Holographic images used in optically variable devices (OVD) are usually manufactured by embossing a desired holographic pattern onto a carrier material. First, the desired pattern needs to be created in a photosensitive material called photoresist by optical interference of two or more laser beams on the surface of the photoresist. Once a holographic pattern is formed in the photosensitive material, it is developed and then metallized and placed into a plating tank where a “grandmother” shim containing the holographic pattern is electroformed. That shim is used for electroforming one of more subsequent “mother” and “daughter” shims that are placed on a roller or cylinder to emboss the final holographic patterns on the final substrate or carrier, such as a thin plastic film. The substrate is usually a thin plastic film passed through a set of rollers, where heat and pressure are used to emboss the holographic pattern from the shim onto the thin plastic film. It should be noted that the terms “cylinder” and “roller” will be used throughout this description interchangeably. Alternatively, interfering laser beams can be employed to ablate a material to directly write the desired holographic patterns onto the material, creating a dot matrix holographic pattern. The process of direct writing involves ablating the material to form pixel-sized interference patterns, or diffraction gratings, of certain frequency and orientation.

When a shim is wrapped around an embossing cylinder, the ends of the shim form a seam along the length of the cylinder. The seam often breaks the holographic pattern and causes breaks in the embossed holographic images on the carrier as the cylinder rotates during the embossing step. It is usually very difficult to eliminate the shim line in the final embossed product, which shim line can be particularly noticeable in continuous holographic patterns. Since having such a seam on the cylinder is undesirable, several methods of producing seamless or semi seamless embossing cylinders have been proposed.

One of the known methods for generating seamless or semi seamless patterns is based on preparing a silicone rubber mold of a holographic pattern that has been created on a cylindrical surface by transferring or overlapping a dot matrix or diffraction foil design. For example, a published PCT application WO 91/01225 describes a method of producing an embossing machine roller by producing a master roller carrying an overall relief image, casting a hollow intermediate mold around the master roller to form an inverted relief image, then removing the intermediate mold and using it to form the outer surface of a cylindrical outer layer of a relatively soft resilient material. That method proposes an embossing machine roller that is formed by rolling a blank roller against a harder die having the desired relief under sufficient pressure to emboss the image onto the outer surface of the roller, repeating the rolling operation until the desired number of images or apparent overall image appear on the roller. If the roller is supported to prevent distortions during the rolling operation, the image embossed on the roller can have a reduced appearance of the seam line.

A method of creating a seamless printing master for use with an embossing roll to produce a seamless ultimate pattern was described in U.S. Pat. No. 5,483,890. A material capable of hardening is applied to the surface of a positive printing master section. The positive printing master section is then pressed onto the embossing roll and the hardenable material is allowed to cure to a hardened state. The positive printing master is then removed to expose a negative printing master region adhered to the embossing roll. The process can be repeated by either using the original positive printing master section or using a different positive printing master section. The resulting roll will have a negative printing master affixed to it with reduced appearance of seams.

A cylindrical tool or a belt embossing tool that can be used to emboss a substrate while reducing the undesirable effect of seams was described in U.S. Pat. No. 4,923,572. A generally cylindrical image transfer or embossing tool, which can be used for embossing a web of material in a continuous manner, is made by placing in conforming relationship a seamless coating or layer of an embossable material around the outer surface of a cylinder. A desired pattern is stamped over the entire exposed surface of the embossable material supported by the rigid cylinder. An electroform of the stamped pattern is then made by electrodeposition of nickel and a reinforcement layer is applied over the pattern electroform. The cylinder is removed to leave, in the form of a cylinder, a pattern carrier of the embossed layer, the electroformed pattern and the reinforcement layer. The embossed layer is stripped from the cylindrical electroformed pattern carrier, producing in a plating mandrel of the electroformed pattern and reinforcement layer. A second electroform is then made by electro deposition of a metal on the first electroform which is on the interior of the plating mandrel. The second electroform is removed from the plating composite and can be used to emboss webs of material in continuous manner. The described method involves a tool for stamping on a curved surface an image or pattern which is to be replicated. The stamping tool has a curved stamping surface carrying an embossed image or pattern. The radius of curvature of the stamping surface matches the radius of curvature of a cylindrical surface which is to be stamped so as to transfer the image or pattern which is to be replicated.

The method described in U.S. Pat. No. 5,327,825 discloses a cylindrical surface either already provided or coated with a layer of an embossable material. The embossable material accepts a pattern in a prepared state and maintains such pattern in its normal state. The desirable pattern is impressed into the embossable layer to complete the die. If some curing step is required, it is performed prior to using the die. Where the embossable material layer is heated in preparation for receiving the pattern from a stamp, the cooling process is sufficient to secure the pattern in the die. Subsequently, a protective or reinforcement layer can be provided in order to render the die and the pattern therein more durable. The die is in the form of a cylinder having a cylindrical surface with a layer of the micro-embossable material. The cylinder is prepared (cleaned and etched) to receive the silver layer, which is plated onto the cylinder. The silver layer is then heated in preparation for receiving the pattern from a concave-shaped stamping surface which has a radius matching the radius of the cylindrical surface of the cylinder. The stamp carrying the pattern is also heated in preparation for the micro-embossing operation. Upon micro-embossing the pattern into the pure silver layer on the cylindrical surface of the die, the die or the stamp carrying the pattern is rotationally and linearly indexed.

U.S. Pat. No. 6,222,157 describes a method for continuously etching patterns into a moving substrate using an energy source, such as electron beam, ion beam and/or a laser beam, and a mask. A pattern is directly and continuously etched on a substrate by ablation without the use of an intermediate layer, such as a photoresist.

The above described methods are often confined to a limited number of holographic patterns that can be embossed onto the rollers or embossing cylinders. Moreover, such methods often do not provide a totally seamless design or a seamless rainbow holographic pattern, mainly because the overlapping, stamping or patching methods still leave slightly visible shim or patch lines or cause pattern interruptions and overlaps on the embossing cylinders. It would be therefore desirable to provide a method of producing a seamless embossing cylinder which can be used for seamless embossing of a variety of holographic patterns of various designs and sizes onto a carrier material.

### SUMMARY OF THE INVENTION

The present invention addressed the above-described need by using laser ablation to direct write dot matrix holographic patterns onto the surface of coatings deposited on an embossing cylinder. In the preferred embodiment of the invention the coatings are polymeric. The desired holographic pattern is ablated on the surface of the coating, or substrate, by interfering at least two laser beams directly onto the polymeric coating of the embossing cylinder in the pixel-by-pixel manner. The direct write laser ablation technique eliminates the size limitations of the holographic pattern created on the surface of the embossing cylinder, the need to combine smaller images to create a larger shim and the very need to use the shims, since large seamless embossing cylinders can be directly pixel-by-pixel ablated to form larger sized images of a great variety. The polymeric coatings for further direct write laser ablation can be deposited onto the embossing cylinder by various methods, including, but not limited to, molding or coating.

According to one of the embodiments of the present invention, a master cylinder is exposed to two or more interfering laser beams ablating the surface of the master cylinder. The exposure of the surface of the cylinder to the interfering beams occurs in a pixel-by-pixel manner across the surface and the circumference of the cylinder. Each holographic pattern is comprised of a plurality of pixels on the surface of the cylinder. Each pixel of the holographic pattern is formed by the direct write ablation process using two interfering laser beams, wherein each pixel comprises a diffraction grating of a certain pitch and orientation. The position and structure of each pixel deposited by the process is controlled by a computer and a position device. The color of light diffracted from a pixel and visible to an observer is determined by the pitch of the diffraction grating associated with that particular pixel and can be varied with great precision. The direction at which an observer will see the light diffracted from that pixel is determined by the orientation of the diffraction grating, which also can be varied with great precision. The pitch and the orientation of a diffraction grating associated with a particular pixel are controlled by the optical laser ablation system forming the pixels on the surface of the cylinder.

The method of the present invention is also used to provide a seamless molded cylinder suitable for direct writing of the holographic patterns without having to use shims . According to the method, a master metal cylinder is coated with a layer of an optically clear material which is later cured. A first additional layer of a more resilient material, such as silicone rubber, is coated on the optically clear layer and later cured. A second layer of the resilient material, such as silicone rubber, is formed by evenly coating a grooved mandrel with a structurally resilient silicone rubber to form an outer surface of the molding sleeve. The silicone coated master cylinder and the molding sleeve and then placed into a molding tube, after which step an additional silicone rubber is pumped into the molding tube to form a master mold sleeve. The mold is then cured to obtain the maximum strength. Once the molding sleeve is completed, the sleeve is inserted into a second molding tube and a slightly undersized embossing cylinder is inserted into the second molding tube, creating a cylindrical cavity between the embossing cylinder and the molding sleeve. A molding polymer, such as resin, is then pumped into the cavity and cured. The embossing cylinder is then removed and the mold can be used again. The surface of the embossing cylinder is now ready to be laser ablated in accordance with the direct write pixel-by-pixel seamless holographic pattern generation described in detail below.

Another method for preparing a cylinder for the direct write pixel-by-pixel laser ablation comprises fabricating a highly polished cylindrical mold of a slightly larger diameter than the embossing cylinder, inserting the embossing cylinder into the mold and pumping a liquid polymer, such as resin, into the cavity between the embossing cylinder and the mold. Then the polymer is cured and the coated embossing cylinder is extracted out of the mold. To facilitate to the extraction of the coated cylinder, the inside surface of the mold can be coated with a mold release agent. The mold itself can be designed of two or more parts to make it easier to remove the mold from the coated embossing cylinder, which is ready for pixel-by-pixel laser ablation of the holographic patterns.

Alternatively, the embossing cylinder can be liquid coated by means or a ring system, blade system, or application roller system. Also, a UV curable coating can be used.

### BRIEF DESCRIPTION OF THE DRAWINGS

FIG. 1 is an enlarged plane view of a portion of a seamless substrate with pixels.

FIG. 2 is a schematic representation of laser ablation of a pixel.

FIG. 3 is a schematic representation of an ablated diffraction grating.

FIG. 4 is a schematic representation of a seamless substrate with a direct write system.

FIG. 5 is a view of a portion of a roller coated with a substrate ablated in a pixel-by-pixel manner.

FIG. 6 is a view of an embodiment of the invention.

FIG. 7 is a schematic representation of the system of the invention.

### DETAILED DESCRIPTION OF THE INVENTION

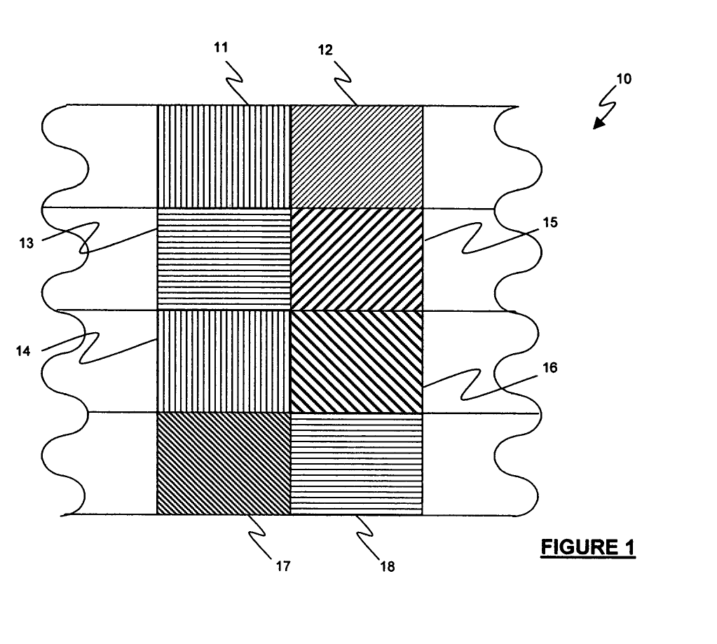

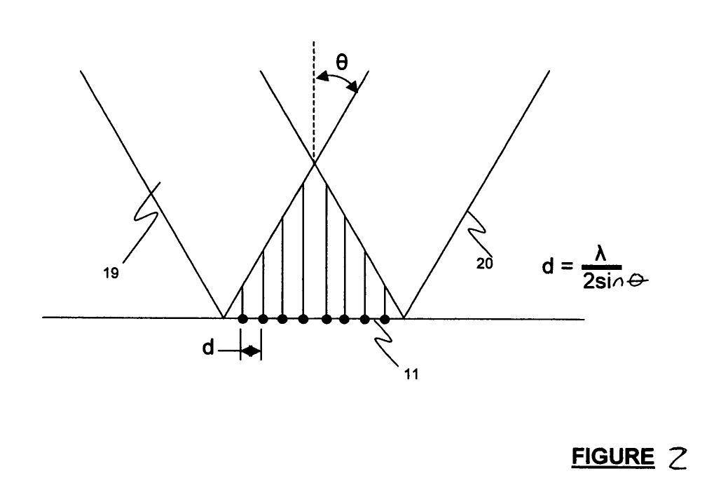

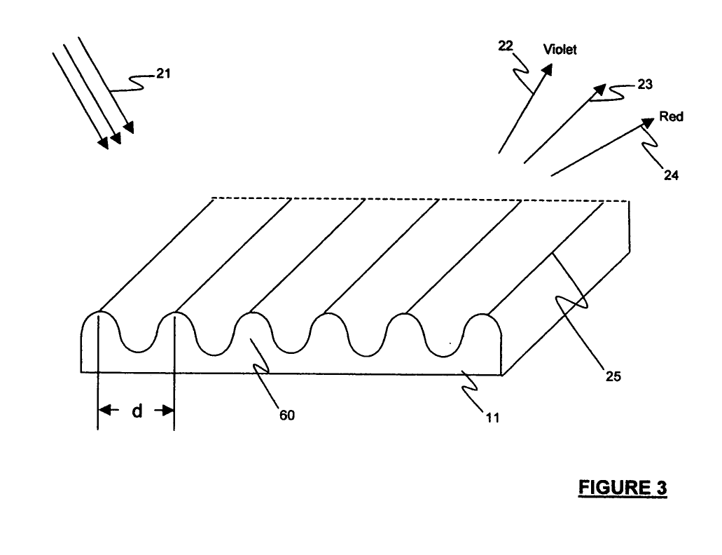

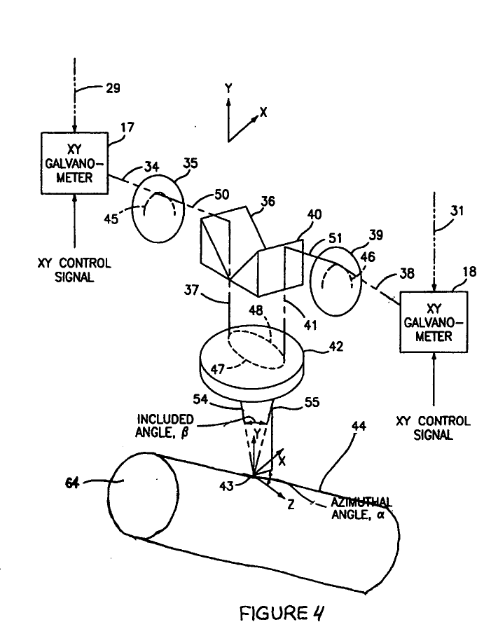

Provided in FIG. 1 is an illustrative portion 10 of a seamless substrate of the present invention with enlarged views of diffraction gratings in several pixels (11-18) ablated by interfering laser beams. In particular, shown in FIG. 1 are diffraction gratings of different pitches (a grating pitch can be defined as a distance between the adjacent crests or grooves), and different orientations of the grooves or crests relative to some direction. Each diffraction grating in each pixel is created by interfering two laser beams 19 and 20 on the surface of the seamless substrate, as shown in FIG. 2 with regard to pixel 11. The interfering laser beams 19 and 20 form an interference pattern characterized by a number of periodic maxima and minima in the laser intensity with a period (pitch) d. Period d is defined by the diffraction equation as d=λ/2 sinθ. The intensity maxima have sufficient energy to ablate the material of a substrate 60 at pixel 11 and form a diffraction grating 25 in pixel 11 with a pitch d, as shown in FIG. 3. For the best results in the ablation process, substrate 60 is preferably coated with an outer layer made of a material particularly suitable for being ablated by a laser. In particular, the outer layer can be a polymer layer, such as an epoxy molding resin, acrylated epoxies, acrylated acrylics, polyamides, polyimides, polysulfones, PET (polyethylene terephthalate), PMMA (polymethyl metacrylate), PTFE (polytetra fluoroethylene), or polycarbonate. As seen in FIG. 3, white light 21 comprising light of different wavelengths is incident on diffraction grating 25. In accordance with the diffraction equation the light of a longer wavelength diffracts off the diffraction grating at larger angles (red light 24 in FIG. 3), while the light of a shorter wavelength diffracts at a smaller angles (violet light 22 in FIG. 3 and light 23 of intermediate wavelength in FIG. 3). Depending on an angle at which an observer looks at pixel 11, the observer will see light of a particular color. An optical system for ablating a seamless substrate in a pixel-by-pixel fashion has been described in U.S. Pat. No. 6,388,780 assigned to Illinois Tool Works, the assignee of the present invention, which patent is incorporated herein by reference in its entirety. In particular, shown in FIG. 4 is an embodiment of the optical system comprising collimating lenses 35 and 39, prisms 36 and 40, and condensing lens system 42, which are provided to direct laser beams 54 and 55 onto substrate 44 of cylinder 63 and interfere the beams on pixel 43. Galvoscanners 17 and 18 deflect each one of the two beams. A set of dotted semicircles depicts a variety of loci, or positions, along optical paths of the two beams as they are deflected by galvoscanners 17 and 18. More specifically, by applying appropriate electronic control signals to X, Y galvanometer 17, beam 34 can be deflected so that it passes through collimating lens 35 at any desired point on locus 45. Beam 38, on the other hand, can be correspondingly deflected so that it passes through collimating lens 39 at any desired point on locus 46. Because of the complementary relationship between the two X, Y galvanometers, these points on loci 45 and 46 will be at mirror image locations, provided only that the electronic deflection control signals applied to both galvanometers are the same. Each so-deflected beam then continues toward the nearest prism (prism 36 for one continuing beam half and prism 40 for the other). These continuing beams are designated in FIG. 3 by reference numerals 50 and 51, respectively.

Due to the collimating nature of lenses 35 and 39, those continuing beams 50 and 51 maintain the same mirror image relationships as they had when passing through the collimating lenses 35, 39. Each of the two prisms 36 and 40 functions to redirect the respective beams 50, 51. The resulting beams exiting these prisms are designated in FIG. 3 by reference numerals 37 and 41, respectively.

In arriving at condensing lens system 42, these redirected beams 37 and 41 can again be located at various points on semi-circular virtual locus 47 and 48, respectively, depending upon the deflections previously imparted to beams 34, 38 by X, Y galvanometers 17, 18 in response to applied electronic control signals.

However, semi-circular loci 45 and 46 are in parallel, laterally spread-apart planes and have their curvatures in the same direction. In contrast, semi-circular loci 47 and 48 are in a common plane and have their curvatures in opposite directions. In fact, by reasonably careful implementation and adjustment of the optical components discussed so far, these semi-circular loci 47 and 48 can be positioned close enough to each other so that they resemble the two halves of a complete circle.

Assuming again that the same control signals are applied to X, Y galvanometers 17, 18, it can be shown that beam halves 37, 41 will arrive at condensing lens system 42 at diametrically opposite locations on the two loci 47 and 48. Moreover, this diametrically opposite relationship will persist, even if the control signals for galvanometers 17, 18 are changed so that azimuthal locations of beams 37 and 41 are displaced along their respective loci 47, 48, provided that these changes are also equal.

Beams 37, 41 pass through condensing lens system 42, becoming beams 54, 55 which converge at pixel location 43. This pixel will therefore have a maximum holographic direction determined by the azimuthal locations on loci 47 and 48 from which these converging beams 54, 55 originate.

It is believed to be apparent that the locations on loci 47 and 48 at which beams 37, 41 arrive at the condensing lens system 42 can be changed at will by the simple expedient of appropriately adjusting the electronic control signals applied to X, Y galvanometers 17, 18. In turn, such changes will change the azimuthal directions from which beams 54 and 55 reach pixel location 43 on surface 44 of cylinder 63, as shown in FIG. 3, and therefore also the maximum holographic direction of that pixel.

As for pixel coloration, it is also believed to be apparent that the radii of semi-circular loci 47 and 48 can also be changed at will, by appropriately adjusting the values of the electronic control signals applied to X, Y galvanometers 17, 18. In turn, such changes will change the included angle between beams 54 and 55 reaching pixel location 43, and thereby also the holographic coloration of that pixel. Thus, the invention enables the complete control of both of these pixel parameters, using as the only non-stationary elements the low-inertia mirrors of the two X, Y galvanometers 17, 18.

In order to prevent impairment of the holographic effect produced by the invention, it is desirable to prevent defocusing of the reunited beams due to small, unintended variations in the optimum distance between the condensing lens system 42 and the surface 44 on which the pixels are to be formed through ablation by these beam halves. Such variations can stem from simple irregularities in the surface of the substrate. Therefore, means are preferably provided to maintain that distance constant. This can consist of a “follower”, (not shown) riding on surface 44 and detecting any distance variation, plus means for moving the lens system 42 toward or away from the surface 44 in a compensating manner.

To form each pixel in a pixel-by-pixel manner similar to those utilized in forming pixel 43 in accordance with the present invention, surface 44 is ablated by the two interfering laser beams of sufficient power, impinging on surface 44 at the desired pixel locations.

It is important to note that while a very specific embodiment of the optical system for practicing the method of the present invention is described with regard to FIG. 4, a variety of optical systems of different design can be employed to produce pixel-by-pixel formation of diffraction gratings on surface 44 by ablating surface 44 with at least two interfering laser beams. For example, if a laser beam is generated by a laser source, then any system and method outputting two beams interfering at pixel location 43 on surface 44 will provide the necessary two interfering beams to ablate the surface and form a diffraction grating in that pixel. A diffraction grating can be used to produce a number of diffracted beams from an original laser beam in accordance with the diffraction equation d-mλ/sinθ, wherein m is an integer corresponding to a diffraction order. At least two diffracted beams can be used to interfere on surface 44 and ablate a diffraction grating in the desired pixel. A fiber optical system can be used to couple one of more laser beams into the optical fibers and propagate at least two beams through the optical system to interfere on surface 44.

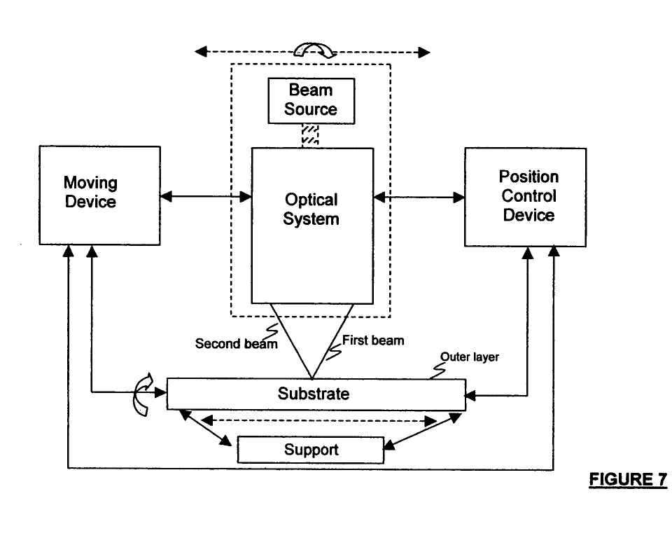

As shown schematically in FIG. 7, an optical system receiving at least one laser beam from a beam source and outputting at least two interfering laser beams converging on surface 44 to ablate the surface and form a diffraction grating at a pixel location is suitable for and is contemplated by the pixel-by-pixel direct write technique of the present invention. The interfering laser beams are shown as first and second beams in FIG. 7 interfering on the substrate. In order for the interfering laser beams to ablate a plurality of gratings in a pixel-by-pixel manner to form a desired holographic pattern on the outer surface of the substrate, the interfering beams should move along the surface of the substrate to the location of the next pixel to be ablated. Of course, it is contemplated that two different diffraction gratings can be recorded within the same pixel, which can be accomplished by varying the included angle (shown as β in FIG. 4) between the interfering laser beams, by varying the azimuthal angle (shown as α in FIG. 4) or varying both the included angle and the azimuthal angle, or interfering more than two laser beams into the same pixel.

To converge the two interfering laser beams into a second pixel, different from an already ablated first pixel, a position control device is used to determine where on the surface of the substrate this second position should be. Then, in accordance with such determination, a moving means is employed to move the two laser beams and the surface of the substrate relative to each other to allow the two beams to interfere at the second pixel and ablate the second diffraction grating in the second pixel. To perform such relative motion, either the laser beams can be moved (with or without the optical system, depending on the design), or the substrate can be moved (linearly, rotationally, or linearly-rotationally), or the beams and the substrate each can all engage in motion resulting in converging the two interfering beams onto the second pixel. The translational or rotational motion of the beams is depicted in FIG. 7 by the dashed horizontal arrow and by the rotating arrow, and any superposition of linear and rotational motion can be used to move the interfering beams. Similarly, motion of the substrate can be accomplished by rotating or linearly displacing the substrate or by any superposition of the linear and rotational motions.

Referring generally to FIG. 7, a system for holographically ablating a seamless substrate is shown to have an outer layer capable of being ablated by a laser. The system has an optical system comprising means for providing at least two laser beams, such as a first laser beam and a second laser beam, interfering at an included angle and an azimuthal angle (not shown in FIG. 7). Position control means for controlling relative motion of the outer layer and the two laser beams provides selecting a location of a predetermined pixel on the outer layer. Supporting means for securing the seamless substrate at a distance from the optical means sufficient for the two laser beams to interfere at the predetermined pixel on the outer layer is also shown in FIG. 7. Means for moving the seamless substrate and the two laser beams relative to each other accomplishes moving either the interfering laser beams or the seamless substrate or both relative to each other in such a way that the interfering beams impinge on the outer layer ablate different pixels.

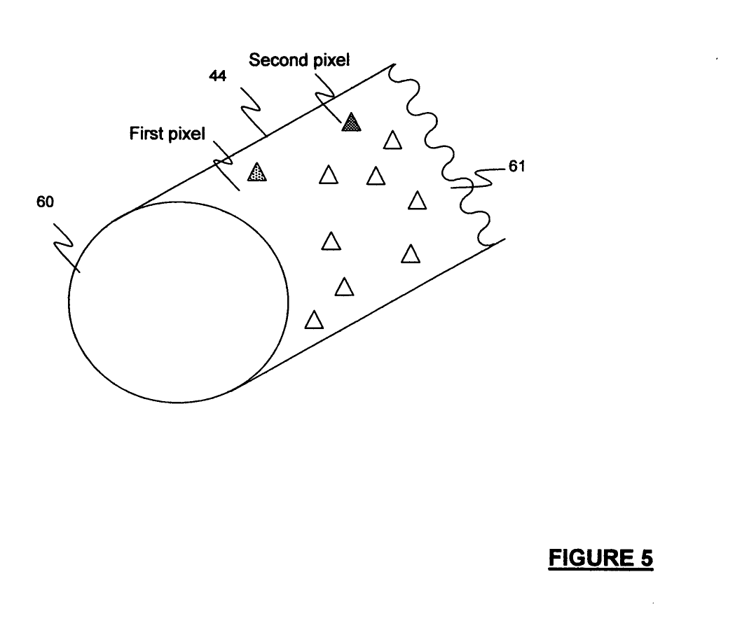

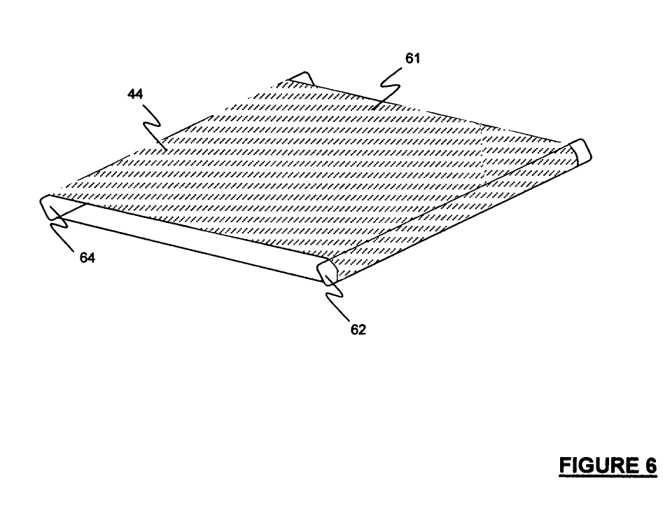

By interfering at least two laser beams on surface 44 of seamless substrate 60 in a pixel-by-pixel manner following from a first pixel to a second pixel and so on as necessary to provide a holographic diffraction pattern 61, shown in FIG. 5, the desired holographic diffraction pattern can be directly written on seamless substrate 60 without having to use photoresist materials to record the holographic pattern and later use electroforming and go through several generations of shims to come up with the final shim ready to be wrapped around an embossing cylinder. As illustrated in FIG. 5, the seamless substrate can be a roller or a cylinder, or, as shown in FIG. 6, the seamless substrate can be a seamless belt with the directly written holographic pattern 61 on surface 44 of the belt. Two rollers 62 and 64 can be utilized when the belt is used for embossing a film or another type of carrier material on which a holographic pattern can be embossed.

In accordance with the method of the present invention, embossing a substrate coated with a polymer layer comprises directing at least two laser beams onto the polymer layer to interfere the laser beams at included and azimuthal angles. The interfering laser beams impinge on the outer surface on the polymer layer at a first location and define a first pixel of a first predetermined size. Interfering laser beams at the first pixel causes ablation of the outer surface of the polymer layer and formation of a first diffraction grating. The formed grating will have the first predetermined size, pitch and orientation, depending on the dimensional characteristics of the leaser beams, an included angle at which the beams interfere, and an azimuthal angle at which the beams ablate the surface. Subsequently, the interfering laser beams impinge on the outer surface of the polymer layer at a second location and define a second pixel of the second predetermined size on the outer surface. The interfering beams ablate the outer surface of the polymer layer and form a second diffraction grating of the second predetermined size, pitch and orientation. The size of a pixel can be controlled by varying such characteristics of the beams as a cross-sectional shape and size. One of the ways to vary the beam characteristics is to use appropriate apertures. The interfering laser beams can be moved from the first pixel to the final pixel to ablate the desired holographic pattern in the polymer layer.

The substrate on which a pixel-by-pixel holographic pattern is recorded can be in the form of a roller or any other suitable shape. The laser beams interfering to ablate the outer layer can be pulsing laser beams. It also contemplated by the present invention that more than one optical system producing more than one pair of interfering beams can be used to ablate the outer layer of the substrate at more than one locations simultaneously to increase efficiency and speed of the pixel-by-pixel recordation process of seamless substrates, which essentially improves the process when a large sized holographic patterns needs to be produced. It also contemplated that the substrate on which a holographic pattern is directly written by the system and method of the present invention can be an embossing base, such as an embossing cylinder used for embossing the pattern on a carrier, or a master base itself used for producing embossing tools.

It should be understood that the invention described herein is not limited to the specific disclosed embodiments and that modifications to the invention can be made without departing from the scope of the invention described in the following claims.

1. A method of embossing a substrate, the method comprising:
providing the substrate having a polymer layer with an outer surface;
directing at least two laser beams onto the polymer layer to interfere the laser beams at an included and azimuthal angles and to cause the interfering laser beams to impinge on the outer surface at a first location, the interfering laser beams defining a first pixel of first predetermined size on the outer surface;
causing the interfering laser beams to ablate the outer surface of the polymer layer and form a first diffraction grating of the first predetermined size, pitch and orientation;
causing the interfering laser beams to impinge on the outer surface of the polymer layer at a second location and define a second pixel of the second predetermined size on the outer surface; and
causing the interfering beams to ablate the outer surface of the polymer layer and form a second diffraction grating of the second predetermined size, pitch and orientation.

2. The method of claim 1, wherein providing the substrate comprises providing a roller.

3. The method of claim 1, wherein causing the interfering beams to impinge on the outer surface at the second location is accomplished by rotational, linear or rotational-linear movement of the substrate.

4. The method of claim 3, wherein the substrate is a roller.

5. The method of claim 1, wherein causing the interfering beams to impinge on the outer surface at the second location is accomplished by moving the interfering beams.

6. The method of claim 1, wherein the polymer layer is made of an epoxy molding resin, acrylated epoxies, acrylated acrylics, polyamides, polyimides, polysulfones, PET (polyethylene terephthalate), PMMA (Polymethyl metacrylate), PTFE (polytetra fluoroethylene), or polycarbonate.

7. The method of claim 1, wherein at least two laser beams are pulsing laser beams.

8. The method of claim 1, wherein defining the second diffraction grating of the second pitch comprises altering the included angle between the interfering laser beams.

9. The method of claim 1, wherein defining the second diffraction grating of the second orientation comprises altering the azimuthal angle of the interfering laser beams.

10. The method of claim 1, wherein the first location coincides with the second location.

11. A method for directly writing a holographic pattern on a seamless base, the holographic pattern comprising a plurality of pixels, the method comprising:
providing the seamless base comprising an outer surface;
providing a first and a second interfering laser beams, the first and second laser beams interfering on the outer at an included angle and at an azimuthal angle;
forming a plurality of diffraction gratings on the outer surface by ablating the outer surface with the first and the second interfering laser beams, the plurality of diffraction gratings corresponding to the plurality of pixels, each diffraction grating having a pitch and an orientation determined by the included angle and the azimuthal angle of the interfering laser beams ablating the outer surface, the plurality of pixels corresponding to the holographic pattern.

12. The method of claim 11, further comprising providing the first and the second interfering laser beams by means of an optical system having a common laser source.

13. The method of claim 11, wherein providing the seamless base comprises providing an embossing base or a master base.

14. The method of claim 11, wherein forming a plurality of diffraction gratings on the outer surface by ablating the outer surface comprises linearly or rotationally moving the seamless base relative to the first and the second interfering laser beams.

15. The method of claim 11, wherein forming a plurality of diffraction gratings on the outer surface by ablating the outer surface comprises moving the first and the second interfering laser beams relative to the seamless base.

16. The method of claim 11, further comprising defining a size of each pixel by controlling cross-sections of the first and the second interfering laser beams.

17. The method of claim 11, wherein providing the first and the second interfering laser beams comprises providing pulsing laser beams.

18. The method of claim 11, wherein the outer surface of the seamless base is made of an epoxy molding resin, acrylated epoxies, acrylated acrylics, polyamides, polyimides, polysulfones, PET (polyethylene terephthalate), PMMA (polymethyl metacrylate), PTFE (polytetra fluoroethylene), or polycarbonate.

19. The method of claim 14, further comprising providing a position control device and a computer for moving the seamless base relative to the first and the second interfering laser beams.

20. A method of seamlessly creating a holographic pattern on a surface, the method comprising:
providing an optical system defining an angle of interference of a first and a second laser beams, the optical system having a component for varying the angle of interference; and
creating the pattern in a pixel-by-pixel fashion with the holographic pattern comprising a plurality of diffraction gratings by ablating the surface with the first and the second laser beams impinging on the surface, thereby forming a plurality of pixels corresponding to the plurality of the diffraction gratings, the pitch of each diffraction grating being defined by the angle of interference.

21. The method of claim 20, further comprising utilizing the component for varying the angle of interference to emboss the plurality of diffraction gratings having various pitches.

22. The method of claim 20, further comprising providing means for varying an azimuthal angle of the first and the second laser beams.

23. The method of claim 22, further comprising varying the azimuthal angle to emboss the plurality of diffraction gratings having various orientations.

24. The method of claim 20, wherein creating the pattern comprises creating the pattern on a cylinder or an embossing belt.

25. The method of claim 20, wherein creating the pattern is computer controlled.

26. The method of claim 20, wherein the surface is a polymeric surface.

27. A system for holographically ablating a seamless substrate having an outer layer capable of being ablated by a laser, the system comprising:
an optical system comprising means for providing at least two laser beams interfering at an included angle and an azimuthal angle;
position control means for controlling relative motion of the outer layer and the two laser beams, thereby selecting a location of a predetermined pixel on the outer layer;
supporting means for securing the seamless substrate at a distance from the optical means sufficient for the two laser beams to interfere at the predetermined pixel on the outer layer; and
means for moving the seamless substrate and the two laser beams relative to each other.

28. The system of claim 27, further comprising means for varying the included angle and the azimuthal angle.

29. The system of claim 27, wherein means for moving serve to move the seamless substrate and the two laser beams relative to each other in a pixel-by-pixel fashion characterized by ablation of a diffraction grating in each predetermined pixel in each location.

30. The system of claim 27, wherein the optical system further comprises at least one galvoscanner for varying the included angle between the two laser beams.

31. The system of claim 27, wherein the seamless substrate is an embossing roller or belt.

32. The system of claim 27, wherein the outer layer of the seamless substrate is made of an epoxy molding resin, acrylated epoxies, acrylated acrylics, polyamides, polyimides, polysulfones, PET (polyethylene terephthalate), PMMA (polymethyl metacrylate), PTFE (polytetra fluoroethylene), or polycarbonate.

33. The system of claim 29, wherein means for moving move the seamless substrate.

34. The system of claim 29, wherein means for moving move the two laser beams.
